(19) United States
(12) Patent Application Publication
(10) Pub. No.: US 2022/0243947 A1
(43) Pub. Date: Aug. 4, 2022

(54) PROGRAMMABLE THERMOSTAT HAVING AN INDOOR AIR QUALITY (IAQ) SENSOR

(71) Applicant: Venstar, Inc., Chatsworth, CA (US)

(72) Inventors: Steven Dushane, Granada Hills, CA (US); Mustafa Oransel, Agoura Hills, CA (US)

(73) Assignee: Venstar, Inc., Chatsworth, CA (US)

(21) Appl. No.: 17/166,643

(22) Filed: Feb. 3, 2021

(51) Int. Cl. F24F 11/72; F24F 11/64; F24F 11/523; F24F 11/59

(52) U.S. Cl. CPC F24F 11/72; F24F 11/64; F24F 2110/66; F24F 11/59; F24F 11/523

(57) ABSTRACT

A programmable thermostat having an indoor air quality sensor, where the programmable sensor is configured to control a building's air handling system, is disclosed. The programmable thermostat continuously monitors the air quality of the indoor environment and determines if the measurements of the indoor air quality has surpassed previously selected, user-specified air quality thresholds which indicates the presence of excessive indoor air contaminants. When excessive indoor air contaminants are detected, the programmable thermostat activates the building's air handling system to purify the indoor air quality. The air may be purified by one or more techniques such as by activating the ventilation to force indoor air through a filter, or by opening fresh air dampers to allow outdoor air to enter the indoor environment and dilute the air contaminants, or by activating other air purification devices such as UV light air purifiers or ionizers.

### BACKGROUND OF THE INVENTION

### 1. Field of the Invention

The present invention relates in general to programmable thermostats for controlling air handling systems for heating, ventilation, and cooling. More particularly, the invention is directed to programmable thermostats having Indoor Air Quality (“IAQ”) sensors for monitoring and controlling the air quality of an indoor environment.

### 2. Description of the Related Art

Air handling systems are employed to regulate the indoor ambient temperature of buildings and are often controlled by thermostats. These air handling systems may also have air filtration systems and other devices which may improve the indoor air quality. The quality of the indoor air may vary greatly within a building as a result of activities and occupancy. Hence, the air handling system should be activated to purify the indoor air in response to the current indoor air quality.

Accordingly, a need exists to provide thermostats which monitors and improves the indoor air quality of buildings.

### SUMMARY OF THE INVENTION

In the first aspect, a programmable thermostat configured to control an air handling system is disclosed. The thermostat comprises an onboard indoor air quality (“IAQ”) sensor providing a measure of an indoor air quality of an environment, a user interface, a controller coupled to the IAQ sensor and the user interface, the controller configured to control an air handling system, and a communications interface coupled to the controller, the communications interface communicating with a remote computing device, the communications interface transmitting status of the thermostat and receiving commands instructing controller to operate within environmental set-points, the environmental set-points comprise user-specified air quality thresholds. When the measure of the indoor air quality compared to the user-specified air quality thresholds indicate that an indoor air of the environment requires purification, the controller activates the air-handling system to purify the indoor air of the environment.

In a first preferred embodiment, the controller activates the air-handling system to purify the indoor air of the environment comprises the controller activates the ventilation of the air handling system. The controller activates the air-handling system to purify the indoor air of the environment preferably comprises the controller activates the fresh air dampers to allow outdoor air to enter the environment. The controller activates the air-handling system to purify the indoor air of the environment preferably comprises the controller activates the air-handling system for a period of time between a minimum runtime and a maximum runtime per hour. The measure of indoor air quality of the environment preferably includes an IAQ index parameter. The measure of indoor air quality of the environment preferably includes detection of volatile organic compounds (“VOCs”). The measure of indoor air quality of the environment preferably includes detection of Carbon Dioxide (“CO₂”). The remote computing device is preferably configured to execute a software application, the software application displaying an indication of the status of the thermostat, the software application enabling a user to enable the air purification function and establish the user-specified air quality thresholds.

In a second aspect, a method of operating an air handling system controlled by a programmable thermostat having a controller and an onboard indoor air quality (“IAQ”) sensor, the programmable thermostat in communication with a remote computing device is disclosed. The method comprises receiving commands from a remote computing device instructing a controller of a thermostat to operate an air handling system within environmental set-points, the environmental set-points comprise user-specified air quality thresholds, determining a measure of an indoor air quality of an environment by an onboard indoor air quality (“IAQ”) sensor, communicating the measure of an indoor air quality of an environment by an onboard indoor air quality (“IAQ”) sensor to the controller, comparing the user-specified air quality thresholds to the measure of an indoor air quality of an environment to determine whether the environment requires purification, and activating by the controller the air-handling system to purify the indoor air of the environment.

In a second preferred embodiment, activating by the controller the air-handling system to purify the indoor air of the environment comprises activating by the controller the ventilation of the air handling system. Activating by the controller the air-handling system to purify the indoor air of the environment preferably comprises the controller activating the fresh air dampers to allow outdoor air to enter the environment. Activating by the controller the air-handling system to purify the indoor air of the environment preferably comprises the controller activating the air-handling system for a period of time between a minimum runtime and a maximum runtime per hour. The measure of indoor air quality of the environment preferably includes an IAQ index parameter. The measure of indoor air quality of the environment preferably includes detection of volatile organic compounds (“VOCs”). The measure of indoor air quality of the environment preferably includes detection of Carbon Dioxide (“CO₂”).

The method of operating an air handling system controlled by the programmable thermostat having the controller and the onboard indoor air quality (“IAQ”) sensor, the programmable thermostat in communication with the remote computing device preferably further comprises executing a software application on the remote computing device, displaying an indication of the status of the thermostat, and receiving commands from a user to enable the air purification function and establish the user-specified air quality thresholds.

In a third aspect, a system configured to control an air handling system is disclosed. The system comprises a programmable thermostat comprising an onboard indoor air quality (“IAQ”) sensor providing a measure of an indoor air quality of an environment, a user interface, a controller coupled to the IAQ sensor and the user interface, the controller configured to control an air handling system, and a communications interface coupled to the controller, the communications interface communicating with a remote computing device, the communications interface transmitting status of the thermostat and receiving commands instructing controller to operate within environmental set-points, the environmental set-points comprise user-specified air quality thresholds. The system further comprises one or more sensors spaced throughout an environment, the one or more sensors having indoor air quality (“IAQ”) sensor providing a measure of an indoor air quality of an environment proximate to each of the one or more sensors. When the measure of the indoor air quality compared to the user-specified air quality thresholds indicate that an indoor air of the environment requires purification, the controller activates the air-handling system to purify the indoor air of the environment.

In a third preferred embodiment, the system further comprises a software application executing on the remote computing device, the software displaying an indication of the status of the thermostat and the one or more sensors, the software application enabling a user to enable the air purification function and establish the user-specified air quality thresholds. The software application enables a user to established user-specified air quality thresholds based on a selection of the thermostat and the one or more sensors. The controller activates the air-handling system to purify the indoor air of the environment preferably comprises the controller activates the ventilation of the air handling system.

These and other features and advantages of the invention will become more apparent with a description of preferred embodiments in reference to the associated drawings.

### DESCRIPTION OF THE DRAWINGS

FIG. 1 is a block, schematic diagram of a programmable thermostat having an indoor air quality (“IAQ”) sensor controlling an air handling system in one or more embodiments.

FIG. 2 is a block, schematic diagram of the programmable thermostat illustrating communication links to various components and devices in an embodiment.

FIG. 3 is a schematic, block diagram of programmable thermostat having an IAQ sensor in communication with a remote user via the Internet and a Computing Cloud.

FIG. 4 is a flowchart illustrating an exemplary method of operating an air handling system controlled by a programmable thermostat.

FIG. 5 is a block, schematic diagram of a programmable thermostat in communication with one or more remote sensors in an embodiment.

FIG. 6 is a block, schematic diagram of the exemplary sensor illustrating communication links to various components and devices in an embodiment.

FIG. 7 is a schematic, block diagram of a system comprising a programmable thermostat having an IAQ sensor and one or more remote sensors in communication with a remote user via the Internet and a Computing Cloud.

FIG. 8 is a screenshot of a display of a remote, desktop computer running a web-based software application for communicating with a programmable thermostat in an embodiment.

FIG. 9 is a screenshot of a status-page presenting the current status of various programmable thermostats.

FIG. 10 is a screenshot of status card of a specific thermostat, which is displayed when activated by engaging with the cards shown in screenshot of FIG. 9.

FIG. 11 is a screenshot of the display showing that various settings may be selected after selecting the three dots as shown in FIG. 10.

FIG. 12 is a screenshot showing the sensor settings webpage which is presented after selecting “Sensors” shown in the screenshot of FIG. 11.

FIG. 13 is a screenshot of the sensor-setting webpage showing a pop-up, interactive table activated when a user places the cursor over the IAQ icon.

FIG. 14 is a screenshot of the sensor-setting webpage showing a pop-up, interactive table activated showing the air quality history when a user places the cursor over the “High” value of the IAQ icon.

FIG. 15 is a screenshot of a display of a mobile display executing a software app showing the current status and control options for a programable thermostat.

FIG. 16 is a screenshot of a display of a mobile display executing a software app showing the control options for a programable thermostat.

FIG. 17 is a screenshot of a display of a mobile display executing a software app showing the control options for onboard IAQ sensors for a programable thermostat.

FIG. 18 is a screenshot of a display of a mobile display executing a software app showing additional control options for onboard IAQ sensors for a programable thermostat.

### DETAILED DESCRIPTION OF THE PREFERRED EMBODIMENTS

While most people are aware that outdoor air pollution may affect their health and well-being, many people may not realize that indoor air pollution may also have even more harmful effects. In fact, recent studies suggest that indoor air may have two to five times the concentration of harmful contaminants as compared to that of outdoor air. Moreover, the effects of indoor air pollution are of further concern as most people spend most of their time indoors. Short term effects of exposure to contaminants in indoor air may result in symptoms such as headaches and fatigue, as well as irritation of the eyes, throat, and lungs. Long term effects of exposure to contaminants include heart disease, respiratory diseases, and cancer.

There are many sources of indoor air contaminants including those resulting from the use of cleaning supplies and from the emission of gases from building materials, carpets, and paints. Other sources include contaminated outdoor air having pollen, dust, and vehicle exhaust that may seep into the indoor environment. Other less-obvious sources of indoor air contaminants may result from cooking and preparation of food, the use of deodorizers or fragrances, the storage and disposal of food, and from daily activities such as cleaning, sweeping, and vacuuming.

More specifically, common indoor air contaminants include gasses such as Volatile Organic Compounds (“VOCs”) and Carbon Dioxide (“CO₂”), as well as particulate matter. VOCs can emanate from cleaning supplies, paints, furnishings, glues, adhesives, and alcohol. Carbon dioxide is generated from respiration as well as from the burning of carbon and organic compounds. Particulate matter may be generated from cooking, combustion activities such as through the burning of candles, use of fireplaces, the use of unvented space heaters, and cigarette smoking. The relative concentration of the indoor air contaminants may vary greatly throughout the day in response to occupancy and activities that are occurring indoors.

One measurement of air quality may be based on the relative concentration of contaminants and may be expressed as parts per million (ppm). Another measurement of air quality is the Air Quality Index (“AQI”), which presents the air quality as a numerical index. The AQI is determined by mathematical calculations based on pollution concentrations. The value of the AQI ranges from 0 to 500, in which the greater value of AQI represents more unhealthy air quality. The AQI is divided into six, color-coded categories, where each category reflects a specific range of AQI that is associated specific heath concerns. For example, air quality having an AQI value between 0 to 50 reflects air quality that is satisfactory, which poses little or no health risk, and is assigned to the color green. On the other extreme, air having an AQI in the range of 301 to 500 is considered as being hazardous, where there is a health warning of emergency conditions.

In response to the need to monitor indoor air quality, indoor air quality (“IAQ”) sensors are commercially available which can detect a range of gasses such as Volatile Organic Compounds (“VOCs”), Carbon Dioxide (“CO₂”), the presence of particulate matter, and can also detect barometric pressure and temperature. The IAQ sensors may monitor the air quality immediately adjacent to the sensor and can detect temporal changes in air quality.

There are several techniques for controlling and reducing indoor air contaminants. One technique involves activating the ventilation of an air handling system such that contaminated indoor air is forced through one or more air filters to reduce the concentration of particulate matter. For example, the use of a HEPA (“High Efficiency Particulate Air”) filter may remove at least 99.97% of dust, pollen, mold, bacteria, and any airborne particles with a size of 0.3 micrometers or greater. Another technique for controlling indoor air contaminants is to dilute the indoor air with outdoor air by activating fresh air dampers for example. Other techniques include the use of air purifiers such as those that employ ultraviolent (“UV”) light sources to reduce air contaminants such as mold, or air ionizers to remove particles from air.

In one or more embodiments, a programable thermostat having an IAQ sensor is placed in an indoor environment. The indoor environment may comprise residential housing, offices, schools, stores, industrial facilities, or other buildings. The programmable thermostat is configured to control an air handling system such as a heating, ventilation, and air conditioning (“HVAC”) system for example. The programmable thermostat continuously monitors the air quality of the indoor environment and determines if the measurements of the indoor air quality has surpassed previously selected, user-specified air quality thresholds which indicates the presence of excessive indoor air contaminants. When excessive indoor air contaminants are detected, the programmable thermostat will activate the building's HVAC system to purify the indoor air quality. The air may be purified by one or more techniques such as by activating the ventilation to force indoor air through a filter, or by opening fresh air dampers to allow outdoor air to enter the indoor environment and dilute the air contaminants, or by activating other air purification devices such as UV light air purifiers or ionizers. The duration of the air purification may be pre-set for a period of time between a minimum runtime and a maximum runtime per hour.

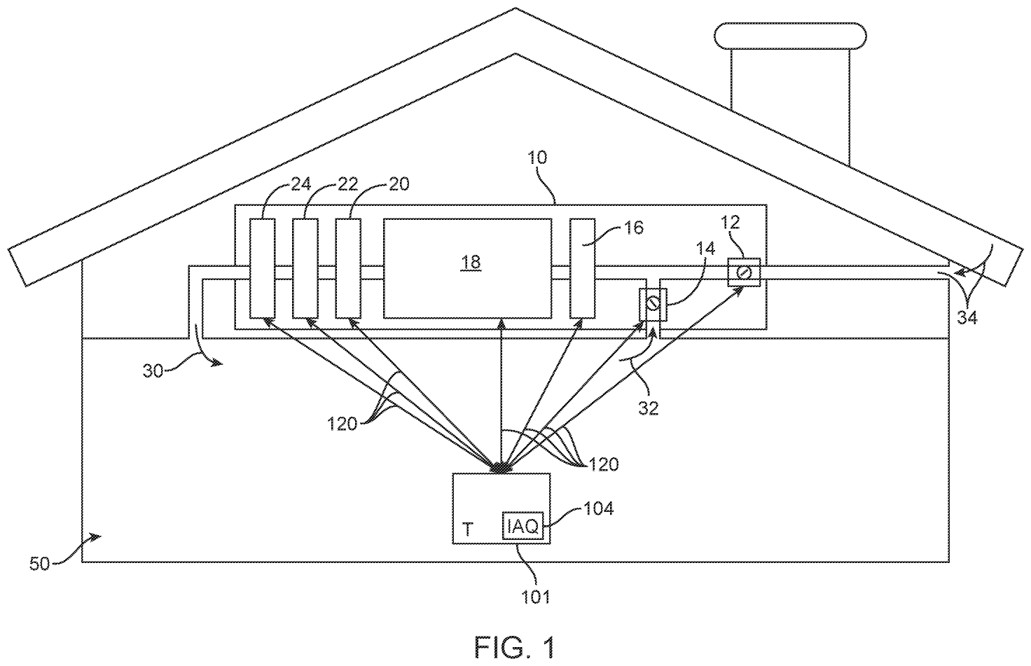

FIG. 1 is a block, schematic diagram of a programmable thermostat 101 having an indoor air quality (“IAQ”) sensor 104 controlling an air handling system 10 in an environment 50 in one or more embodiments. Although the environment 50 in FIG. 1 illustrates a residential house, it shall be understood that this description is for illustration purposes only and that environment 50 may comprise the interior of residential buildings, commercial buildings, schools, offices and other indoor environments in one or more embodiments.

The programmable thermostat 101 is configured to communicate with and control an air handling system 10, depicted schematically as being placed in an attic of the environment 50 in this example. The air handling system 10 may comprise one or more of the following: a fresh air damper 12, a return air damper 14, a filter 16, a HVAC system 18, a UV light air purification system 20, an Ionizer 22, as well as other air purifying devices 24. Return air damper 14 controls the amount of the return air flow 32 entering the air handler 10, and fresh air damper 12 controls the amount of fresh air flow 34 entering the air handling system 10. The air from the fresh air 34 and/or the return air 32 flow through the air handling system 10 returns to the environment 50 by the supply air 30.

The IAQ sensor 104 can detect a range of gasses such as Volatile Organic Compounds (“VOCs”), Carbon Dioxide (“CO₂”) as well as particulate matter. The programmable thermostat 101 can thereby respond by activating the one or more components of the air handling system 10. For example, if a high concentration of particulate matter is detected, the programmable thermostat 101 may activate the ventilation system of the HVAC system 18 to draw the indoor air 32 through the return air damper 14 and though the filter 16. If a high level of VOCs or CO₂ are detected, the programmable thermostat 101 may activate the fresh air damper 12 to allow fresh air from the outside to dilute the indoor air within the environment 50. If the conditions for mold are present, such as by the IAQ detecting high humidity, the programable thermostat 101 may activate the UV light purifier 20.

The programmable thermostat 101 is in communication and in control with the various components of the air handling system 10 as indicated by the bidirectional communication arrows 120. In one or more embodiments, the bidirectional communication arrow 120 may represent a hardwired or a wireless connection.

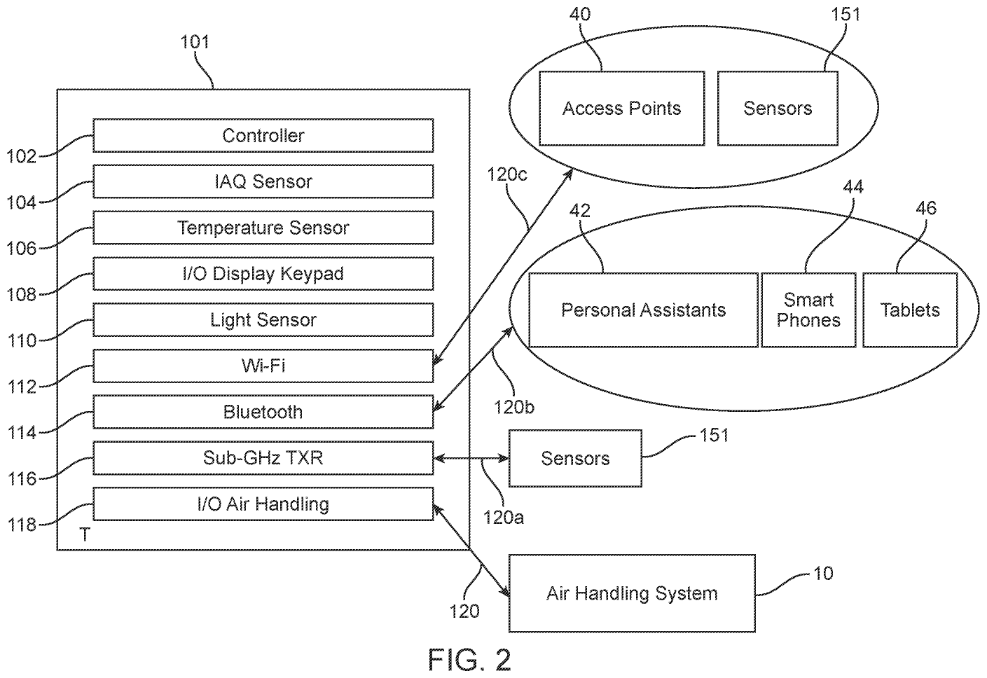

FIG. 2 is a block, schematic diagram of the programmable thermostat 101 illustrating communication links 120-120c to various components and devices in an embodiment. The programmable thermostat 101 may comprise one or more of the following: a controller 102, an IAQ Sensor 104, a temperature sensor 106, an I/O display and keypad 108 (i.e., a user interface), a light sensor 110, a Wi-Fi driver and transceiver 112, a Bluetooth communication device 114, a sub-GHz transceiver 116, and I/O air handling circuitry 118.

The controller 102 may comprise a microcontroller or microprocessor which controls the functions of the programmable thermostat 101 though the execution of software. As used herein, the controller 102 may have RAM or ROM memory included on the chip or may refer to a group of discrete components including a stand-alone micro controller with external memory and other support chips. The temperature sensor 106 is employed to monitor the ambient temperature of the local environment in proximity to the programmable thermostat 101. The I/O display and keypad 108 refers generally to a user interface which may comprise an LCD or LED display which may have touchscreen functionality, discrete LEDs, and one or more mechanical buttons for adjusting the set-point of the programmable thermostat 101. A light sensor 110 may be used to dim the displays during nighttime, or to activate the programmable thermostat 101 when a sudden increase in ambient lighting is detected such by a user turning on the light to a darkened room.

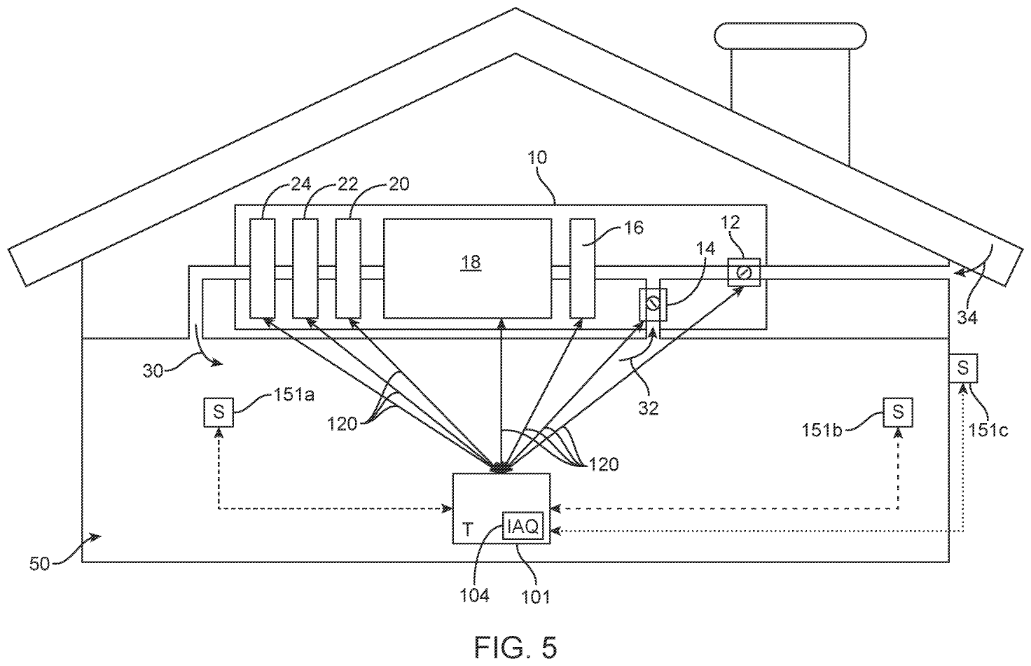

As discussed above, communication link 120 is employed to communicate with and control the air handling system 10. The sub-GHZ transceiver 116 may be employed to communicate with remote sensors 151 (see FIG. 5) located throughout the environment 50 via communication link 120a. The Bluetooth communication device 114 may be employed to communicate to personal assistants 42 (e.g., smart speakers or virtual assistants), smart phones 44, and tablets 46 vi communication link 120b.

The Wi-Fi driver and transceiver 112 may communicate to access point 40 and sensors 151 via communication link 120a. An access point 40 is a networking hardware device that allows Wi-Fi devices to connect to a wired network such as an Ethernet or the Internet. In an embodiment, the Wi-Fi driver and transceiver 112, working through an access point 40, enables the programmable thermostat 101 to communicate to remote locations via the Internet.

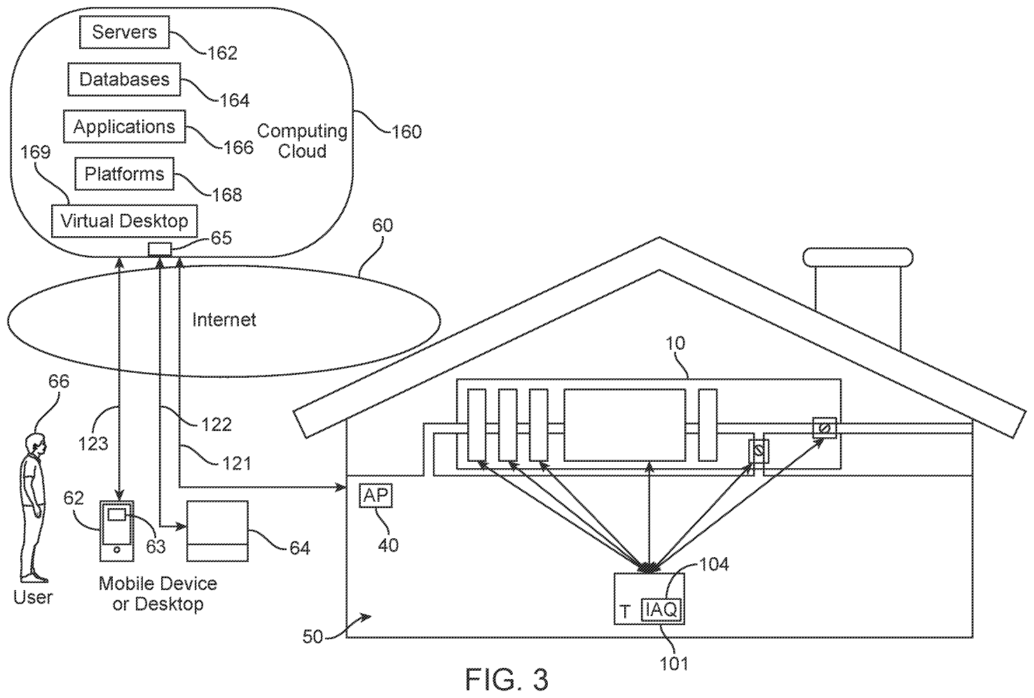

FIG. 3 is a schematic, block diagram of programmable thermostat 101 having an IAQ sensor 104 in communication with a remote user 66 via the Internet 60 and a computing cloud 160. In one or more embodiments, communication links 121,122, and 123 enable a remote user 66, using a mobile device 62 or desktop 64 (i.e., “remote computing device”), to communicate with and program the programmable thermostat 101.

Specifically, communication link 121 enables the programmable thermostat 101 to transmit and receive data with a computing cloud 160 though the Internet 60. For example, the programmable thermostat 101, though Wi-Fi driver and transceiver 112, can communicate to an Access Point 40 through communication link 120c (FIG. 2). The Access Point 40 may then connect to the Internet through communication link 121 to transfer data to the computing cloud 160. Communication links 122 and 123 enable the computing cloud 160 to communicate with the user 66 interacting with a mobile device 62 or desktop 64. In an embodiment, a computing cloud 160 may comprise servers 162, databases 164, applications 166, platforms 168, and virtual desktops 169.

In an embodiment, the user 66 interacts with the mobile device 62 or the desktop 64 through a downloadable software application (“app”) 63 for the mobile device 62 or via a web-based software 65 for the desktop 64. The software app 63 can be run on handheld devices such as smartphones or tablets and can be used for remote monitoring and controlling of programmable thermostats 101. The web-based software 65 provides tools to command and control the programmable thermostat 101 from desktop computers 64.

In one or more embodiments, the programmable thermostat 101 may be adapted for various applications and may be configured as a high-end residential thermostat with air purification monitoring and control, a high-end commercial thermostat with air purification monitoring and control with light sensing, multi-stage devices such as a 2 heat, 4 cool commercial thermostat with air purification monitoring and control with light sensing, and a thermostat specifically designed for the classroom and the school environment thermostat with air purification monitoring and control with light sensing.

The programmable thermostat 101 is available with many features. In one or more embodiments, the programmable thermostat 101 can switch from being non-programable to being programmable in 7-day, 5+2 day, or 1-day schedules. The thermostat 101 is switchable, where it has an automatic changeover or can be set for heating and cooling only. The thermostat 101 can be configured to control humidification, dehumidification, and reheating. The thermostat 101 can accommodate a 365-day holiday programming schedule when connected to a computing cloud. Scrolling information is displayed, and the thermostat 101 can have adjustable timers and dead bands between stages. In an embodiment, the thermostat 101 is configured to accommodate an outdoor sensor providing high and low readouts for the day. The thermostat 101 is configured to control or monitor a second temperature sensor, and can control gas, electric, or heat pumps.

In one or more embodiments, the thermostat 101 has setpoint limiting, can accommodate a Smart or programmable fan, and can accommodate Open ADR2.0b Architectures. The thermostat 101 provides a programmable output, along with compressor protection, and offers a Smart Recovery feature. The thermostat 101 can average one remote sensor with the thermostat 101, is CA Title 24 compliant, and offers a keypad lockout function. The thermostat 101 has an available API, offers a Home/Away “one touch button,” has a bi-color LED indicating a cooling or heating demand, and has a nighttime dimmer. The thermostat is compatible with condensate overflow warning systems with a lock compressor out with display message. The thermostat 101 offers FDD notification and provides a preoccupancy fan purge. The display of the thermostat is configured to accommodate several languages such as English, Spanish, and French.

The thermostat may have separate weekday/weekend schedules, has an “Unoccupied Util” button, may provide an energy saving operation mode, and may have a morning warmup period with a programmable override.

To briefly review, a programmable thermostat 101 is contemplated in one or more embodiments. The programmable thermostat 101 is configured to control an air handling system 10. The air handling system 10 may provide ventilation, cooling, heating, and air purification and may comprise in an embodiment one to more of the following: a fresh air damper 12, a return air damper 14, one or more filters 16, a HVAC system 18, UV lights air purification system 20, and ionizer 22, as well as other forms of air purifiers 24.

The programmable thermostat 101 comprises an onboard indoor air quality (“IAQ”) sensor 104 providing a measure of an indoor air quality of an environment, a user interface 108 (FIG. 2), and a controller 102 coupled to the IAQ sensor 104 and the user interface 108. The controller 102 is configured to control an air handling system 10. The programmable thermostat 101 further comprises a communications interface (e.g., Wi-Fi driver and transceiver 112) coupled to the controller 102, with the communications interface 112 communicating with a remote computing device (e.g., mobile device 62 or desktop 64). The communications interface 112 is configured to transmit the status of the thermostat 101 and receive commands instructing the controller 102 to operate within environmental set-points. In an embodiment, the environmental set-points comprise user-specified air quality thresholds such as values of the index of air quality necessary to activate the purification functions of the air handling system 10. When the measure of the indoor air quality compared to the user-specified air quality thresholds indicate that an indoor air of the environment requires purification, the controller 102 activates the air-handling system 10 to purify the indoor air of the environment 50.

In one or more embodiments, the controller 102 activates the ventilation of the air handling system 10. The controller 102 may activate the air-handling system 10 to purify the indoor air of the environment by opening the fresh air dampers to allow outdoor air to enter the environment 50. The controller 102 may activate the air-handling system 10 for a period of time between a minimum runtime and a maximum runtime per hour.

In an embodiment, the measure of indoor air quality of the environment includes an IAQ index parameter. The measure of indoor air quality of the environment includes detection of volatile organic compounds (“VOCs”). the measure of indoor air quality of the environment includes detection of Carbon Dioxide (“CO₂”). In an embodiment, a remote computing device 62, 64 is configured to execute a software application (e.g., 63 or 65), where the software application 63,65 displays an indication of the status of the thermostat 101, the software application 63, 65 enables a user to enable the air purification function and establish the user-specified air quality thresholds.

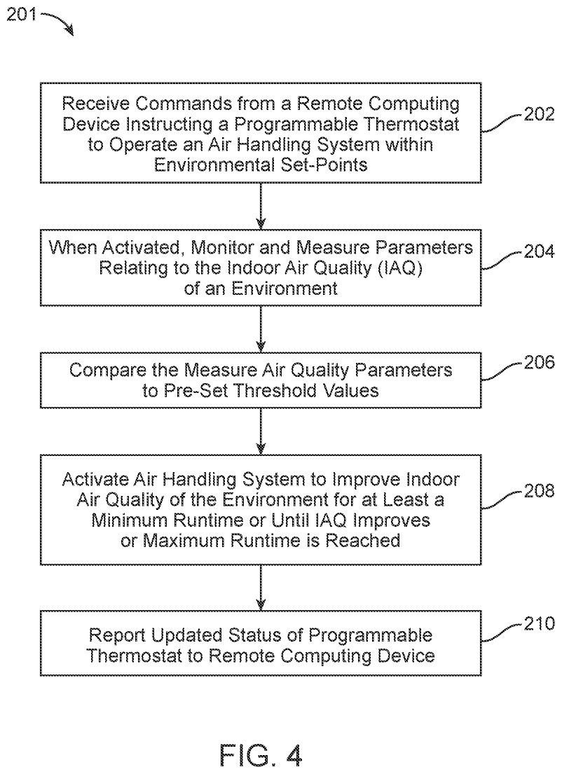

FIG. 4 is a flowchart 201 illustrating an exemplary method of operating an air handling system 10 controlled by a programmable thermostat 101 having a controller 102 and an onboard indoor air quality (“IAQ”) sensor 104. The programmable thermostat 101 is in communication with a remote computing device 62, 64. The programmable thermostat 101 receives commands from a remote computing device 62, 64 instructing the programmable thermostat 101 to activate the air handling system 10 to purify the indoor air within environmental set-points (step 202). In an embodiment, the environmental set-points comprise user-specified air quality thresholds. When activated, the programmable thermostat 101 monitors and measures parameters relating to the indoor air quality of an environment 50 (step 204). The controller 102 compares the measure of the air quality parameter to the user-selected, pre-set environmental threshold values (step 206). The measure of an indoor air quality of an environment by an onboard indoor air quality (“IAQ”) sensor 104 is communicated to the controller 102. The controller 102 activates the air handling system 10 to improve the indoor air quality of the environment 50 by running the ventilation or purification devices for at least a minimum runtime or until the indoor air quality improves sufficiently or a maximum runtime is reached (step 208). The controller 102 then reports the updated status of the programmable thermostat 101 to the remote computing device 62, 64 (step 210).

In an embodiment, the programmable thermostat 101 is in communication with the remote computing device 62, 64, such that activating by the controller 102 of the air-handling system 10 to purify the indoor air of the environment comprises the controller 102 activating the ventilation of the air handling system 10. Activating by the controller 102 of the air-handling system 10 to purify the indoor air of the environment 50 comprises the controller 102 activating the fresh air dampers 12 to allow outdoor air 34 to enter the environment 50. Activating by the controller 102 of the air-handling system 10 to purify the indoor air of the environment comprises the controller 102 activating the air-handling system for a period of time between a minimum runtime and a maximum runtime per hour.

In one or more embodiments, the programmable thermostat 101 is in communication with the remote computing device 62, 64 where the measure of indoor air quality of the environment 50 includes an IAQ index parameter. In an embodiment, the measure of indoor air quality of the environment includes detection of volatile organic compounds (“VOCs”). In one or more embodiments, the measure of indoor air quality of the environment includes detection of Carbon Dioxide (“CO₂”). In one or more embodiments, the programmable thermostat 102 is in communication with the remote computing device 62, 64, and the method further comprises executing a software application 63, 65 on the remote computing device 62, 64, displaying an indication of the status of the thermostat 101, and receiving commands from a user 66 to enable the air purification function and establish the user-specified air quality thresholds.

FIG. 5 is a block, schematic diagram of a programmable thermostat 101 in communication with one or more remote sensors 151 in one or more embodiments. In an embodiment, the programmable thermostat 101 is in communication with remote sensors 151a and 151b located throughout the environment 50, and may be in communication with a sensor 151c placed outdoors to measure the environmental parameters of the outdoor air, such as the temperature, humidity, and outdoor air quality. In an embodiment, the programmable thermostat 101 may be instructed to activate the air purification function of the air handling system 10 based on the remote sensors 151a/b/c, or a combination or average of the remote sensors 151a/b/c.

In an embodiment, the outdoor sensor 151c may provide an indication of the outdoor air quality and temperature, which determine whether the fresh air damper 12 should allow outside air 34 to enter the environment 50. For example, if the outdoor air quality is worse than the indoor air quality, the controller 102 may decide not to open the fresh air dampers 12.

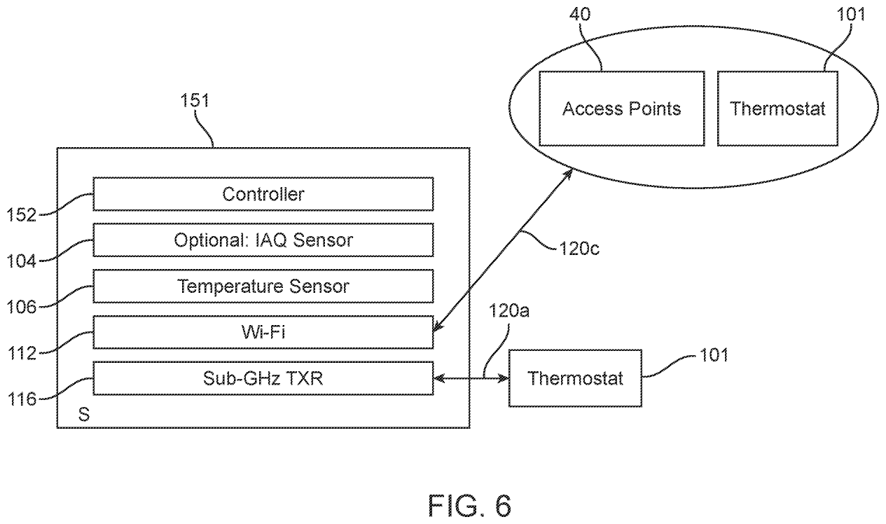

FIG. 6 is a block, schematic diagram of the exemplary sensor 151 illustrating communication links to various components and devices in an embodiment. The sensor may comprise one or more of the following: a controller 152, an optional IAQ sensor 104, a temperature sensor 106, a Wi-Fi driver and transceiver 112, and a sub-GHZ transceiver 116. The sub-GHZ transceiver can communicate to the programmable thermostat 101 vis communication link 120a. The Wi-Fi driver and transceiver 112 may communicate to an access point 40 or to the programmable thermostat 101 via communication link 120.

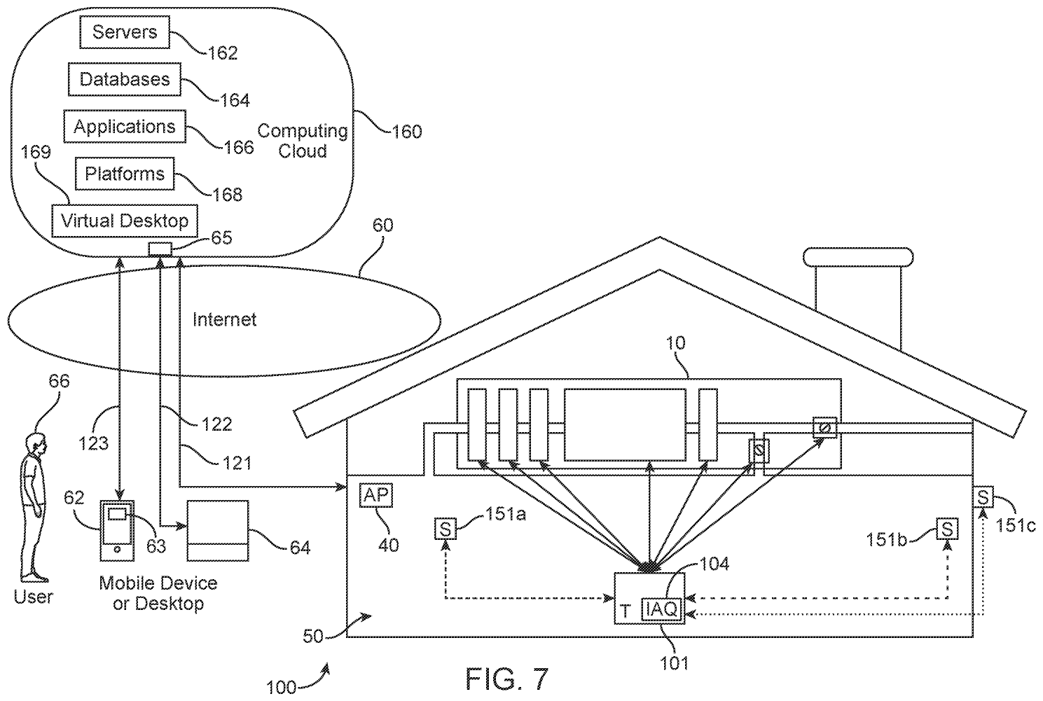

FIG. 7 is a schematic, block diagram of a system 101 comprising a programmable thermostat 101 having an IAQ sensor 104 and one or more remote sensors 151 in communication with a remote user 66 via the Internet 60 and a Computing Cloud 160. As described with respect to the programmable thermostat 101, the communication link 121 enables the sensor 151 to transmit and receive to a computing cloud 160 though the

Internet 60. For example, the sensor 151, though Wi-Fi driver and transceiver 112, can communicate to an Access Point 40 through communication link 120c. The Access Point 40 may then connect to the Internet through communication link 121 to transfer data to the computing cloud 160. Communication links 122 and 123 enable the computing cloud 160 to communicate with the user 66 interacting with a mobile device 62 or desktop 64.

In one or more embodiments, a system 100 is configured to control an air handling system 10. The system 100 comprises a programmable thermostat 101 having an onboard indoor air quality (“IAQ”) sensor 104 providing a measure of an indoor air quality of an environment, a user interface 108 (FIG. 2), and a controller coupled to the IAQ sensor and the user interface, the controller 102 configured to control an air handling system 10.

The programmable thermostat 101 further comprises a communications interface (e.g., Wi-Fi driver and transceiver 112) coupled to the controller 102. The communications interface 112 communicates with a remote computing device (e.g., mobile device 62 or desktop 64). The communications interface 112 configured to transmit the status of the thermostat 101 and receive commands instructing the controller 102 to operate within environmental set-points.

The system 100 further comprises one or more sensors 151a/b/c spaced throughout an environment 50. The one or more sensors may each have indoor air quality (“IAQ”) sensor 104 providing a measure of an indoor air quality of an environment 50 proximate to each of the one or more sensors. When the measure of the indoor air quality compared to the user-specified air quality thresholds indicate that an indoor air of the environment requires purification, the controller 102 activates the air-handling system 10 to purify the indoor air of the environment.

In an embodiment, the system further comprises a software application 63, 65 executing on the remote computing device 62,64. The software 63, 65 displaying an indication of the status of the thermostat 101 and the one or more sensors 151. The software application 63, 65 enables a user 66 to enable the air purification function and establish the user-specified air quality thresholds. The software application 63, 65 enables a user 66 to established user-specified air quality thresholds based on a selection of the thermostat and the one or more sensors 151. In an embodiment, the controller 102 activating the air-handling system 10 to purify the indoor air of the environment comprises 102 activating the ventilation of the air handling system 10.

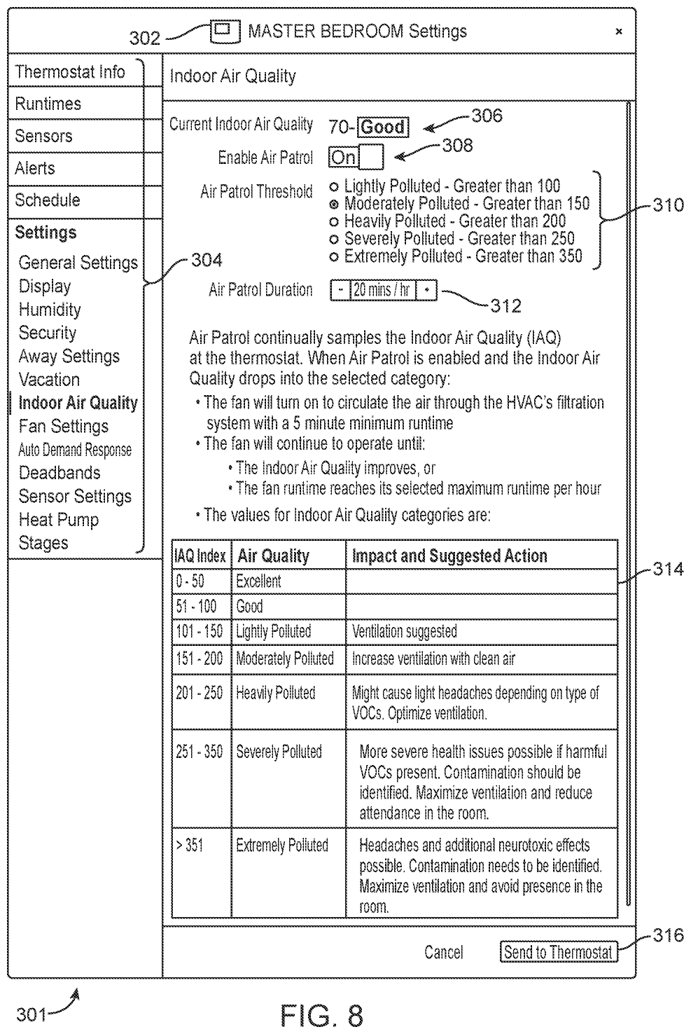

FIGS. 8-14 are screenshots of a desktop device 64 running the web-based software application 65. FIG. 8 is a screenshot of a display of a remote, desktop computer 64 running a web-based software application 65 for communicating with a programmable thermostat 101 in an embodiment. The display enables a remote user 66 to receive the current status of the programmable thermostat 101 as well as enabling the remote user 66 to establish environmental set-points and operating parameters for the programmable thermostat 101. At the top of the screenshot 301, indicia 302 of the location of the specific programmable thermostat 101 being addressed is presented, which, in this example, is labeled as “MASTER BEDROOM Settings.” Along the left side of the screen shot 301 is a table 304 listing various categories of control and settings. In this example, the category labeled “Settings” with the sub-category “Indoor Air Quality” has been selected. The status of the Current Indoor Air Quality 306 is displayed and comprises the numeric value of the AGI (“Air Quality Index”) as well as a text and color indication of the indoor air quality. In this example, the AQI is 70, and the text describing the AQI is “Good” shown against a green background (not shown).

The interactive touchscreen of includes a virtual touchscreen button 308 for enabling the programmable thermostat 101 to activate the air handling system 10 in case of inadequate indoor air quality. In this case, the virtual touchscreen button 308 is “On,” meaning the thermostat is activated.

User-selected air-quality thresholds 310 are presented where the user 66 can select the air quality threshold for activating the air handling system 10 in response to the detection of the current air quality by the IAQ sensor 104. In this example, an air quality threshold of “Moderately Polluted—Greater than 150” is selected, such that the programmable thermostat 101 will activate the air handing system 10 to purify the air should the detected readings of the current air quality exceed 150.

A virtual scroll bar 312 for selecting the runtime of the air purification cycle for the air handling system is presented. In this example, the user 66 selects that the runtime duration shall be 20 minutes per hour. A table 314 for listing the values of the AQI is presented at the bottom of the screenshot 301.

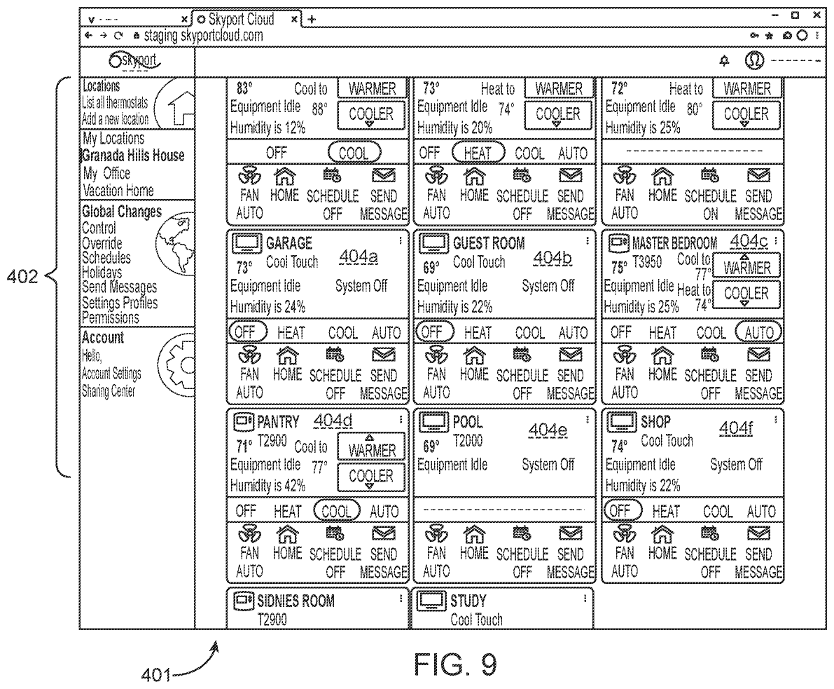

FIG. 9 is a screenshot 401 of a status-page presenting the current status of various programmable thermostats 101. The screenshot 401 includes a column at the left having a listing 402 indicating locations of thermostats, tools to enable changes and updates to the thermostats, and tools for changing account information. The screenshot 401 also shows an array of “cards” 402-404f which present the status of the thermostats under control with this account. In this example, card 404a describes the status of the thermostat in the “GARAGE,”, card 404b describes the status of the thermostat in the “GUEST ROOM,”, and status card 404c displays the status of the thermostat in the “MASTER BEEDROOM” and so forth.

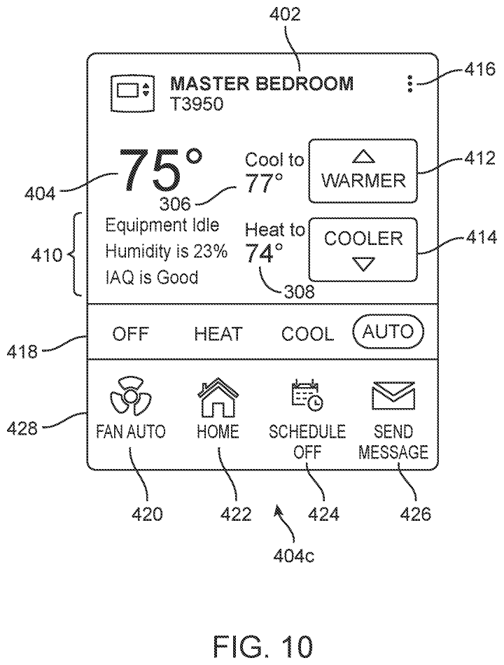

FIG. 10 is a screenshot of status card 404c, which is displayed when activated by engaging with the cards shown in screenshot 401 of FIG. 9. The “card” 404c has indicia 402 of the location of the thermostat (“MASTER BEDROOM”), indicia 404 of the current temperature at that location (“75°”), indicia 410 of the current status (“Equipment Idle, Humidity is 23%, IAQ) is Good which is depicted in green font not shown”), indicia of the upper temperature set-point 306 (“Cool to 77°”), and indicia of the lower temperature set-point 308 (“Heat to 74°”). The status card 404c has a virtual button 412 for increasing the set-point of the temperature of the thermostat as well as a virtual button 414 for decreasing the set-point of the thermostat 101.

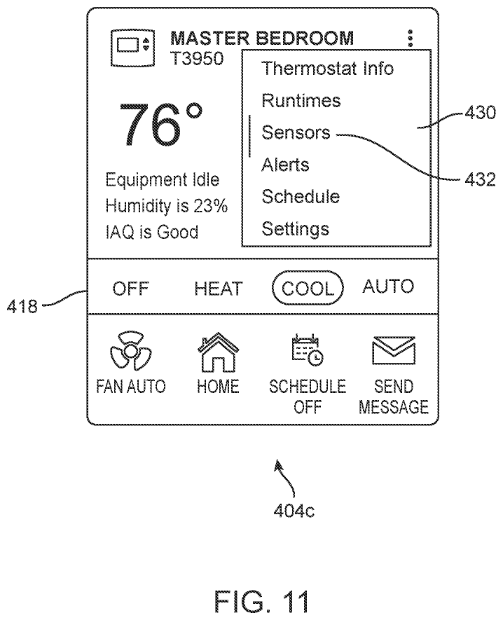

The card 404c has a virtual control panel 318 for controlling the mode of operation of the thermostat (“OFF, HEAT, COOL, AUTO—which is currently selected”). The card 404c has a virtual panel 428 with virtual buttons for selecting tools for controlling the FAN 420, go to HOME 422, SCHEDULE 424, and SEND Message 426. At the upper right corner of the card 404c are 3 buttons 416 for setting up the sensors as shown in FIG. 11.

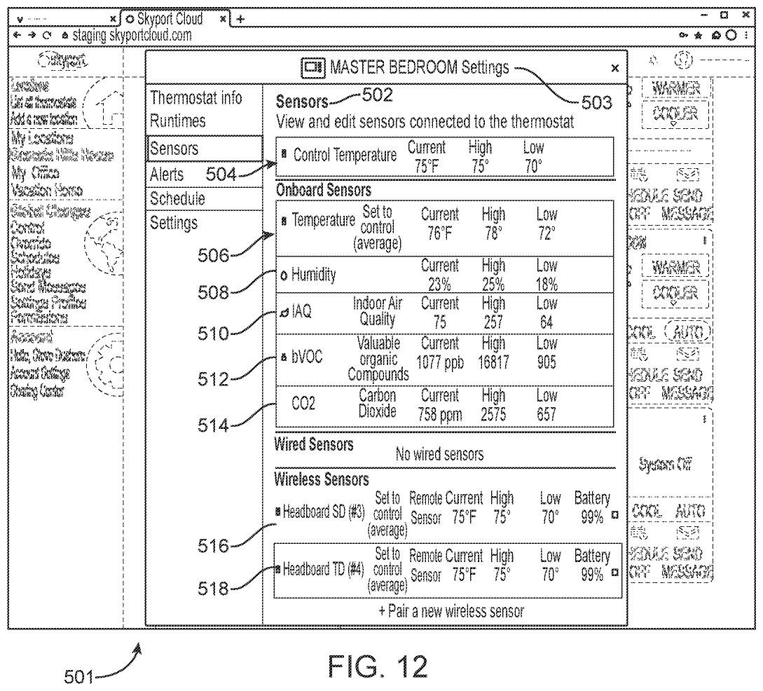

FIG. 11 is a screenshot 404c of the display showing the that various setting may be selected after selecting the three dots 416 as shown in FIG. 10. The display now displays a pop-up window 430 which enables users to access Thermostat Info, Runtimes, Sensors 432, Alerts, Schedule, and Settings. A user selecting Sensors 432 will update the display as shown in FIG. 12.

FIG. 12 is a screenshot 501 showing the sensor settings webpage which is presented after selecting “Sensors” shown in the screenshot of FIG. 11. The screenshot 501 has indicia 503 of the location of the thermostat 101, which is listed as “MASTER BEDROOM” in this example. Indicia of the sensor control 502 illustrate that the display is for controlling and accessing IAQ sensor information.

Indicia for the various parameters of the onboard sensors are shown as temperature 506, humidity 508, IAQ 510, bVOC 512 (“Biogenic Volatile Organic Compounds”), and CO₂ 514. Indicia for wireless sensors are shown as “Headboard SD” 516 and Headboard TD 518

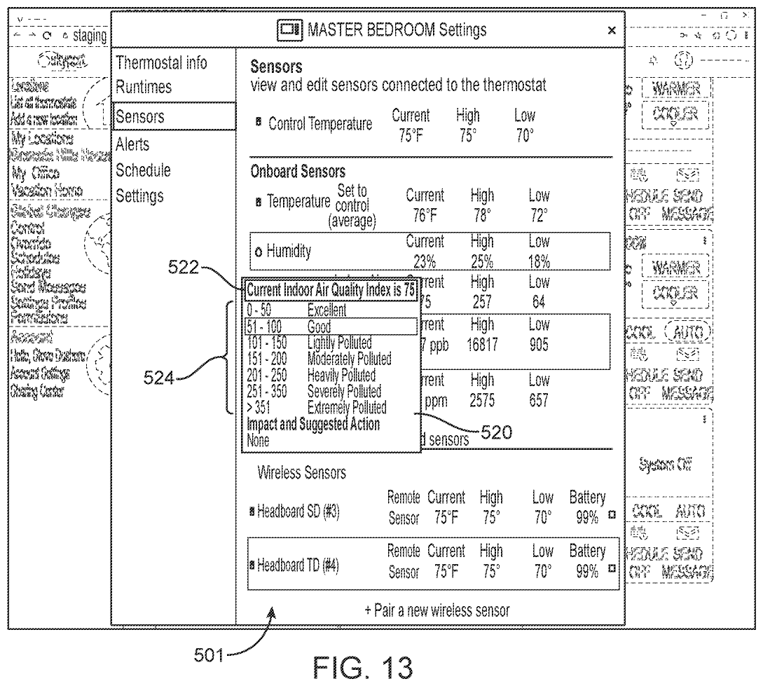

FIG. 13 is a screenshot 501 of the sensor-setting webpage showing a pop-up, interactive table 520 activated when a user places the cursor over the IAQ icon. The pop-up, interactive table 520 comprises indicia of the current indoor air quality 522, and a summary 524 showing the description of the air quality for the numeric values of the Air Quality Index.

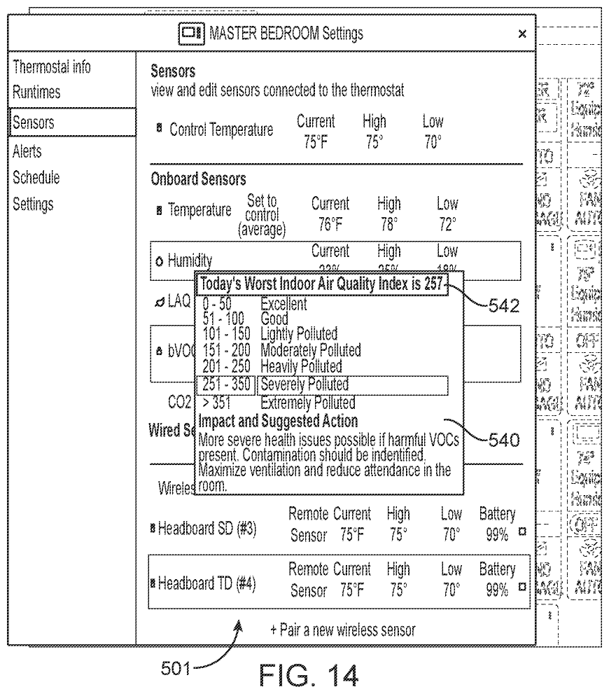

FIG. 14 is a screenshot 501 of the sensor-setting webpage showing a pop-up, interactive table 540 activated showing the air quality history when a user places the cursor over the “High” value of the IAQ icon. The pop-up window 540 presents indicia of “Today's Worst Indoor Air Quality Index” 542 followed a summary showing the description of the air quality for the numeric values of the Air Quality Index.

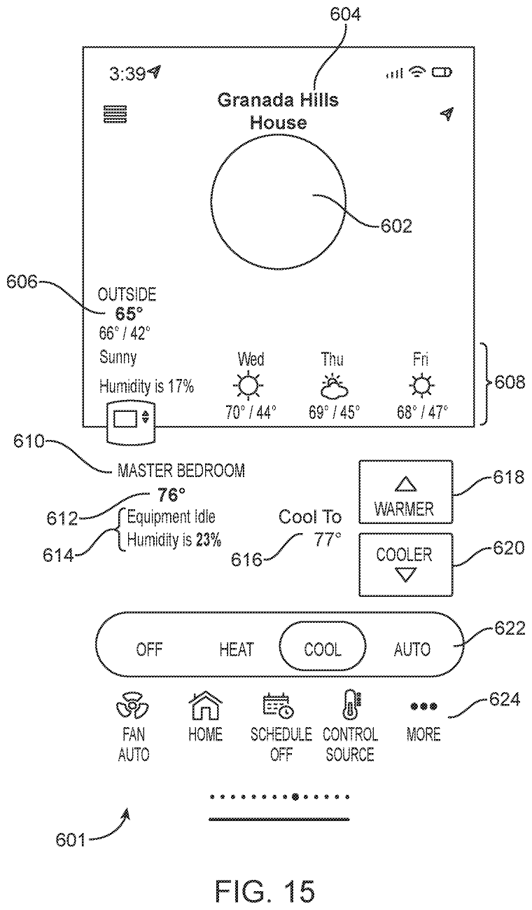

FIG. 15 is a screenshot 601 of a display of a mobile display 62 executing a software app 63 showing the current status and control options for a programable thermostat 101. The display shows indicia 604 of the location of the thermostat 101 (“Granada Hills House”), as well as indica 602 of the current outdoor weather (shown as a full, yellow sun). Indicia of the outside current temperature, expected highs and lows, description of the weather, and the current humidity 606 are also shown (shown as OUTSIDE 65°, 66°/42°, Sunny, Humidity is 17%). Indicia of the current location of the thermostat 610 is show, followed by indicia of the current temperature 612 (76° and indicia of the equipment status and current humidity 614 (Equipment Idle, Humidity is 23%).

Indicia of the current temperature set-point 616 (Cool to 77°) is presented, along with virtual control button for increasing the temperature set-point 618 and a virtual control button for decreasing the temperature et-point 620.

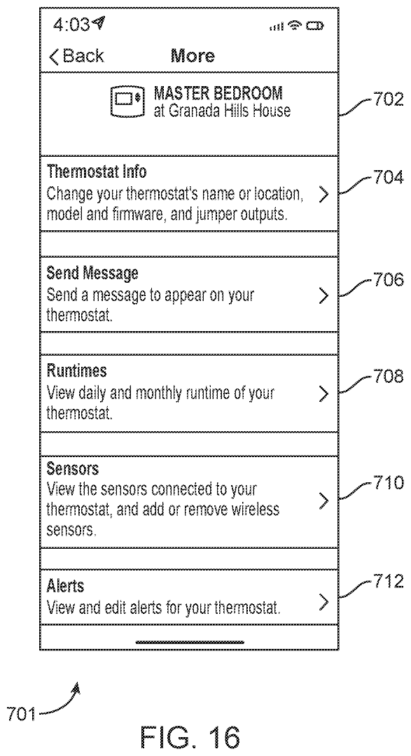

A virtual panel 622 displays the current status and options for controlling the thermostat 101 (OFF, HEAT, COOL-activated, AUTO). A virtual control panel 624 is presented for tools to control the fan, go to the home page, scheduling, control source and indicia for more options, which, when activated, causes the display to present the screenshot 701 illustrated in FIG. 16.

FIG. 16 is a screenshot 701 of a display of a mobile display executing a software app showing the control options for a programable thermostat. The screenshot 701 shows indica of the thermostat under control 702 (MASTER BEDROOM at Granada Hills House) followed by a listing control options for displaying the current Thermostat Info 704, controls for sending a message 706, runtimes 708, sensors 710, and alert settings 712.

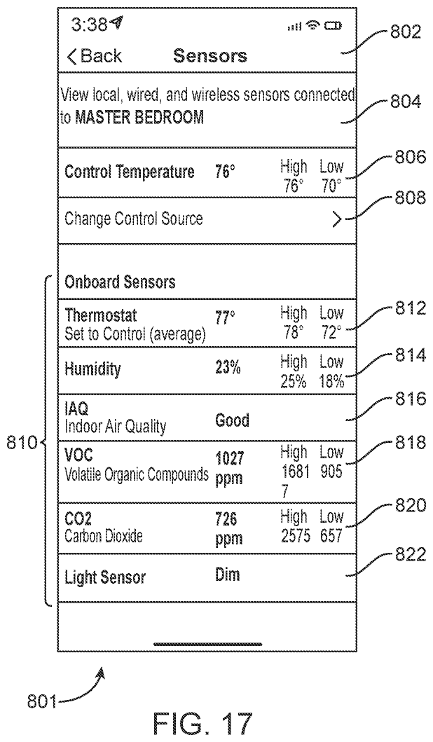

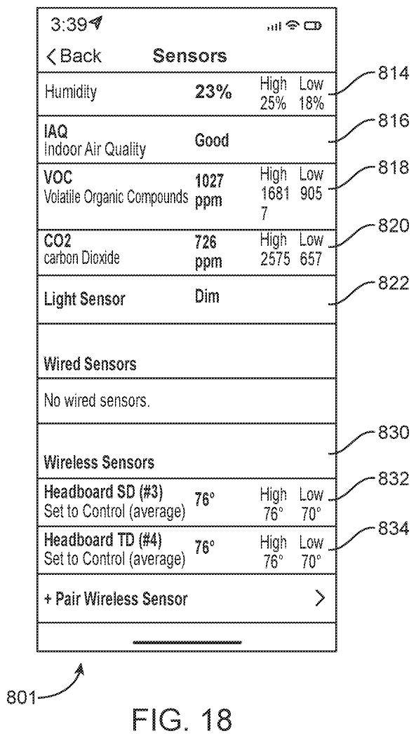

FIGS. 17-18 depicts a screenshot 801 of a display of a mobile display 62 executing a software app 63 showing the control options for onboard IAQ sensors for a programable thermostat. The screenshot 801 presents indicia of the type of control options 802 (“SENSORS”), followed by indica for control options such as ability to view sensors in the MASTER BEDROOM 804, the control temperature 804, and the ability to change control source 808. The status of the onboard sensors 810 comprises the control temperature setpoint 812, the humidity 814, the IAQ 816, the VOC 818, CO₂ 820, and the status of the lighting near the thermostat 822. As shown in FIG. 18, the display can be scrolled down to present status of the Wireless Sensors 830, followed by the sensor status for Headboard SD 832, and Headboard TD 834.

Although the invention has been discussed with reference to specific embodiments, it is apparent and should be understood that the concept can be otherwise embodied to achieve the advantages discussed. The preferred embodiments above have been described primarily as a programmable thermostat having an indoor air quality sensor capable of being configured by a remote user via a mobile device or a desktop. In this regard, the foregoing description of the programmable thermostats is presented for purposes of illustration and description. It shall be apparent that various devices would benefit from having remotely controllable device for measuring and controlling indoor air quality.

Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A programmable thermostat configured to control an air handling system, the thermostat comprising:
an onboard indoor air quality (“IAQ”) sensor providing a measure of an indoor air quality of an environment;
a user interface;
a controller coupled to the IAQ sensor and the user interface, the controller configured to control an air handling system; and,
a communications interface coupled to the controller, the communications interface communicating with a remote computing device, the communications interface transmitting status of the thermostat and receiving commands instructing controller to operate within environmental set-points, the environmental set-points comprise user-specified air quality thresholds;
wherein, when the measure of the indoor air quality compared to the user-specified air quality thresholds indicate that an indoor air of the environment requires purification, the controller activates the air-handling system to purify the indoor air of the environment.

2. The programmable thermostat configured to control an air handling system of claim 1, wherein the controller activates the air-handling system to purify the indoor air of the environment comprises the controller activates the ventilation of the air handling system.

3. The programmable thermostat configured to control an air handling system of claim 1, wherein the controller activates the air-handling system to purify the indoor air of the environment comprises the controller activates the fresh air dampers to allow outdoor air to enter the environment.

4. The programmable thermostat configured to control an air handling system of claim 1, the controller activates the air-handling system to purify the indoor air of the environment comprises the controller activates the air-handling system for a period of time between a minimum runtime and a maximum runtime per hour

5. The programmable thermostat configured to control an air handling system of claim 1, wherein the measure of indoor air quality of the environment includes an IAQ index parameter.

6. The programmable thermostat configured to control an air handling system of claim 1, wherein the measure of indoor air quality of the environment includes detection of volatile organic compounds (“VOCs”).

7. The programmable thermostat configured to control an air handling system of claim 1, wherein the measure of indoor air quality of the environment includes detection of Carbon Dioxide (“CO₂”).

8. The programmable thermostat configured to control an air handling system of claim 1, wherein the remote computing device is configured to execute a software application, the software application displaying an indication of the status of the thermostat, the software application enabling a user to enable the air purification function and establish the user-specified air quality thresholds.

9. A method of operating an air handling system controlled by a programmable thermostat having a controller and an onboard indoor air quality (“IAQ”) sensor, the programmable thermostat in communication with a remote computing device, the method comprising:
receiving commands from a remote computing device instructing a controller of a thermostat to operate an air handling system within environmental set-points, the environmental set-points comprise user-specified air quality thresholds;
determining a measure of an indoor air quality of an environment by an onboard indoor air quality (“IAQ”) sensor;
communicating the measure of an indoor air quality of an environment by an onboard indoor air quality (“IAQ”) sensor to the controller;
comparing the user-specified air quality thresholds to the measure of an indoor air quality of an environment to determine whether the environment requires purification; and,
activating by the controller the air-handling system to purify the indoor air of the environment.

10. The method of operating an air handling system controlled by the programmable thermostat having the controller and the onboard indoor air quality (“IAQ”) sensor, the programmable thermostat in communication with the remote computing device of claim 9, wherein activating by the controller the air-handling system to purify the indoor air of the environment comprises activating by the controller the ventilation of the air handling system.

11. The method of operating an air handling system controlled by the programmable thermostat having the controller and the onboard indoor air quality (“IAQ”) sensor, the programmable thermostat in communication with the remote computing device of claim 9, wherein activating by the controller the air-handling system to purify the indoor air of the environment comprises the controller activating the fresh air dampers to allow outdoor air to enter the environment.

12. The method of operating an air handling system controlled by the programmable thermostat having the controller and the onboard indoor air quality (“IAQ”) sensor, the programmable thermostat in communication with the remote computing device of claim 9, wherein activating by the controller the air-handling system to purify the indoor air of the environment comprises the controller activating the air-handling system for a period of time between a minimum runtime and a maximum runtime per hour

13. The method of operating an air handling system controlled by the programmable thermostat having the controller and the onboard indoor air quality (“IAQ”) sensor, the programmable thermostat in communication with the remote computing device of claim 9, wherein the measure of indoor air quality of the environment includes an IAQ index parameter.

14. The method of operating an air handling system controlled by the programmable thermostat having the controller and the onboard indoor air quality (“IAQ”) sensor, the programmable thermostat in communication with the remote computing device of claim 9, wherein the measure of indoor air quality of the environment includes detection of volatile organic compounds (“VOCs”).

15. The method of operating an air handling system controlled by the programmable thermostat having the controller and the onboard indoor air quality (“IAQ”) sensor, the programmable thermostat in communication with the remote computing device of claim 9, wherein the measure of indoor air quality of the environment includes detection of Carbon Dioxide (“CO₂”).

16. The method of operating an air handling system controlled by the programmable thermostat having the controller and the onboard indoor air quality (“IAQ”) sensor, the programmable thermostat in communication with the remote computing device of claim 9, further comprising:
executing a software application on the remote computing device
displaying an indication of the status of the thermostat; and, receiving commands from a user to enable the air purification function and establish the user-specified air quality thresholds.

17. A system configured to control an air handling system, the system comprising:
a programmable thermostat comprising:
an onboard indoor air quality (“IAQ”) sensor providing a measure of an indoor air quality of an environment;
a user interface;
a controller coupled to the IAQ sensor and the user interface, the controller configured to control an air handling system;
a communications interface coupled to the controller, the communications interface communicating with a remote computing device, the communications interface transmitting status of the thermostat and receiving commands instructing controller to operate within environmental set-points, the environmental set-points comprise user-specified air quality thresholds; and,
one or more sensors spaced throughout an environment, the one or more sensors having indoor air quality (“IAQ”) sensor providing a measure of an indoor air quality of an environment proximate to each of the one or more sensors;
wherein, when the measure of the indoor air quality compared to the user-specified air quality thresholds indicate that an indoor air of the environment requires purification, the controller activates the air-handling system to purify the indoor air of the environment.

18. The system configured to control an air handling system of claim 17, the system further comprising a software application executing on the remote computing device, the software displaying an indication of the status of the thermostat and the one or more sensors, the software application enabling a user to enable the air purification function and establish the user-specified air quality thresholds.

19. The system configured to control an air handling system of claim 18, wherein the software application enables a user to established user-specified air quality thresholds based on a selection of the thermostat and the one or more sensors.

20. The system configured to control an air handling system of claim 17, wherein the controller activates the air-handling system to purify the indoor air of the environment comprises the controller activates the ventilation of the air handling system.
